(19) United States
(12) Patent Application Publication
(10) Pub. No.: US 2017/0285838 A1
(43) Pub. Date: Oct. 5, 2017

(54) METHOD, TERMINAL AND COMPUTER STORAGE MEDIA FOR AWAKENING MOBILE TERMINAL AND APPLICATION

(71) Applicants: Le Holdings (Beijing) Co., Ltd., Beijing (CN); Lemobile Information Technology (Beijing) Co., Ltd., Beijing (CN)

(72) Inventor: Wen Gao, Beijing (CN)

(21) Appl. No.: 15/241,119

(22) Filed: Aug. 19, 2016

Related U.S. Application Data
(63) Continuation of application No. PCT/CN2016/088090, filed on Jul. 1, 2016.

(30) Foreign Application Priority Data
Mar. 29, 2016 (CN) 201610189243.3

(51) Int. Cl. G06F 3/041; G06F 3/044

(52) U.S. Cl. CPC G06F 3/0416; G06F 3/044

(57) ABSTRACT

The disclosure is applicable to the technical field of mobile terminals and provides a method and a system for awakening a mobile terminal and an application. The method includes: collecting a sliding gesture of a user on a screen; matching the sliding gesture with a pre-stored sliding gesture; and, if the match succeeds, unlocking the mobile terminal and opening the application associated with the sliding gesture. The method and system for awakening a mobile terminal and an application provided by the disclosure, by binding a sliding gesture to an application, allow a user to open the application while awakening the mobile terminal through the sliding gesture, bringing a great convenience for a user to quickly open a corresponding application and omitting the process of finding application after awakening a mobile phone.

### CROSS REFERENCE TO RELATED APPLICATIONS

This application is a continuation application of PCT application No. PCT/CN2016/088090, which claims priority to Chinese Patent Application No. 201610189243.3 filed on Mar. 29, 2016, the entire contents of which are incorporated herein by reference.

### TECHNICAL FIELD

The disclosure pertains to the technical field of mobile terminals, and more specifically pertains to a method, a terminal and an application for awakening a mobile terminal and an application.

### BACKGROUND

With the development of mobile terminal related technologies, portable mobile terminals including smart phone bring a great convenience to people's life, and the mobile terminals such as smart phone have been implanted deep into users' life.

In the usage scenario of current mobile terminals such as smart phone, if to open one application, the common operation is to awaken and unlock the mobile terminal through a touch screen, and then find and open the corresponding application. Although this method is simple, it still needs two steps, which is not convenient or fast enough.

### SUMMARY

The disclosure provides a method, a terminal and an application for awakening a mobile terminal, which, by binding a sliding gesture to an application, allow a user to open the application while awakening the mobile terminal through the sliding gesture, omitting the process of finding application after awakening a mobile phone.

The disclosure provides a method for awakening a mobile terminal, including:

collecting a sliding gesture of a user on a screen;

searching and matching the sliding gesture with a pre-stored sliding gesture; and

if the match succeeds, unlocking the mobile terminal and opening the application associated with the sliding gesture.

The disclosure further provides a nonvolatile computer storage media, which has computer executable instructions stored thereon, wherein the computer executable instructions are configured to: collect a sliding gesture of a user on a screen; search and match the sliding gesture with a pre-stored sliding gesture; and if the match is succeeded, unlock the mobile terminal and opening the application associated with the sliding gesture.

The disclosure further provides a terminal for awakening a mobile terminal and an application, including: one or more processors;

a memory;

one or more programs stored in the memory, which, when executed by the one or more processors, are configured to:

collect a sliding gesture of a user on a screen;

search and match the sliding gesture with a pre-stored sliding gesture; and

if the match succeeds, unlock the mobile terminal and open the application associated with the sliding gesture.

From the above embodiments of the disclosure, it can be known that the disclosure provides a method and a terminal for awakening a mobile terminal and an application, which, by binding a sliding gesture to an application, allow a user to open the application while awakening the mobile terminal through the sliding gesture, bringing a great convenience for a user to quickly open a corresponding application and omitting the process of finding application after awakening a mobile phone, and, by which a user can set a gesture corresponding to each application according to his/her preference and habit, with good experience.

### BRIEF DESCRIPTION OF THE DRAWINGS

For a better understanding of the embodiments of the disclosure or the technical scheme of the existing technology, a brief introduction is given below to the drawings needed in the description of the embodiments or existing technology. Obviously, the following drawings are some embodiments of the disclosure simply; for those skilled in the art, other drawings can be obtained according to these drawings without creative work.

FIG. 1 is a structure diagram of a mobile terminal.

FIG. 2 is a flowchart illustrating a method for awakening a mobile terminal and an application provided by the first embodiment of the disclosure.

FIG. 3 is a flowchart illustrating a method for awakening a mobile terminal and an application provided by the second embodiment of the disclosure.

FIG. 4 is a structure diagram of a system for awakening a mobile terminal and an application provided by the third embodiment of the disclosure.

FIG. 5 is a structure diagram of a system for awakening a mobile terminal and an application provided by the fourth embodiment of the disclosure.

FIG. 6 is a hardware configuration diagram of an terminal for awakening a mobile terminal and an application provided by the fifth embodiment of the present disclosure.

### DESCRIPTION OF THE EMBODIMENTS

To make the purpose, the feature and the benefits of the disclosure more apparent and understandable, a clear and complete description is provided to the technical scheme in the embodiments of the disclosure in conjunction with the drawings in the embodiments of the disclosure. Obviously, the embodiments described hereinafter are simply part embodiments of the disclosure, but all the embodiments. All other embodiments obtained by those skilled in the art based on the embodiments in the disclosure without creative work are intended to be included in the scope of protection of the disclosure.

Mobile terminal, or called mobile communication terminal, refers to a computer device which can be used during movement. As network and technology become increasingly broadband-oriented, mobile communication industry will enter a genuine mobile information age. On the other hand, with the rapid development of integrated circuit technologies, mobile terminal already has a powerful processing capability and is becoming a comprehensive information processing platform rather than a simple calling tool.

Modern mobile terminal, as a complete super-mini computer system, already has extremely powerful processing capability (CPU main frequency is close to 2G), memory, curing storage medium and the same operating system as a computer, and can finish complicated processing tasks. Mobile terminal also has rich communication modes; that is, it can complete communications through wireless networks such as Global System for Mobile Communication (GSM), Code Division Multiple Access (CDMA), Wideband Code Division Multiple Access (WCDMA), Enhanced Data Rate for GSM Evolution (EDGE), 3G and the like, or through wireless local area network, Bluetooth and infrared.

Nowadays, mobile terminal can also implement functions such as positioning, information processing, fingerprint scanning, ID card scanning, barcode scanning, Radio Frequency Identification (RFID) scanning, IC card scanning and alcohol content detection, besides calling, photographing, listening to music and playing games, which becomes an important tool for mobile law enforcement, mobile office and mobile commerce. Some mobile terminals are integrated with an interphone. As a deep integration into people's economical and social life, smart terminal in foreign countries has been applied to express, insurance, mobile law enforcement and other fields. In recent years, mobile terminal also becomes more and more widely used in mobile law enforcement and mobile commerce in China.

With the popularity of mobile terminals represented by mobile phone, it is necessary to provide a better and convenient experience for users. The scheme provided by the disclosure can bring a better experience to users.

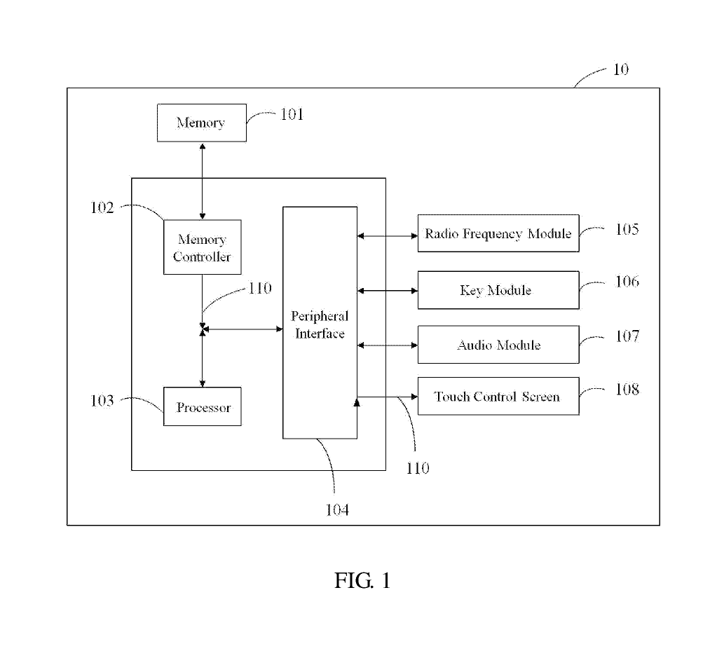

FIG. 1 is a structure diagram of a mobile terminal. The method for awakening a mobile terminal and an application provided by the embodiment of the disclosure can be applied to a mobile terminal 10 as shown in FIG. 1, and the mobile terminal 10 may include but not limited to: smart phone with a fingerprint information acquisition function, tablet computer, wearable smart device and the like.

As shown in FIG. 1, the mobile terminal 10 includes a memory 101, a memory controller 102, one or more processors 103 (only one processor is shown), a peripheral interface 104, a radio frequency module 105, a key module 106, an audio module 107, a touch control screen 108 and a fingerprint module 109, which communicate with each other through one or more communication buses/signal lines 110.

It is understandable that the structure shown in FIG. 1 is simply for illustration but to limit the structure of the mobile terminal. The mobile terminal 10 may include more or fewer components than those shown in FIG. 1, or has a different configuration than that shown in FIG. 1. Each component shown in FIG. 1 may be realized through hardware, software or a combination thereof.

The memory 101 may be configured to store software programs and modules, for example, program instructions/modules corresponding to the method and system for awakening a mobile terminal and an application provided in the embodiment of the disclosure; the processor 103 executes various function applications and data processing by running the software programs and modules stored in the memory 101, that is, to realize the method for awakening a mobile terminal and an application implemented in the mobile terminal 10.

The memory 101 may include high-speed random access memory, also may include non-volatile memory, for example, one or more magnetic storage devices, flash memories, or other non-volatile solid state memories. In some example, the memory 101 may further include a memory remotely set relative to the processor 103. The remote memory can be connected to the mobile terminal 10 through a network. The example of the network includes but not limited to Internet, enterprise Intranet, local area network, mobile communication network and combination thereof. The processor 103 and other possible components can access the memory 101 under the control of the memory controller 102.

The peripheral interface 104 couples various input/output devices to the CPU and memory 101. The processor 103 runs various kinds of software and instructions in the memory 101 so as to execute various functions and data processing of the mobile terminal 10.

The peripheral interface 104, the processor 103 and the memory controller 102 in some embodiments may be realized in a single chip, or in some other embodiments may be realized by a separate chip.

The radio frequency module 105 is configured to receive and transmit an electromagnetic wave and conduct mutual conversion between electromagnetic wave and electrical signal, thereby communicating with a communication network or other devices. The radio frequency module 105 may include various existing circuit elements used to execute the above functions, for example, antenna, radio frequency receiver, digital signal processor, encryption/decryption chip, Subscriber Identity Module (SIM) card, memory and the like. The radio frequency module 105 can communicate with various networks such as Internet, enterprise intranet and preset type wireless network or communicate with other devices through the preset type wireless network. Here, the preset type wireless network may include cellular telephone network, wireless local area network or metropolitan area network, and may use various communication standards, protocols and technologies, which include but not limited to: Global System for Mobile (GSM), Enhanced Data GSM Environment (EDGE), Wideband Code Division Multiple Access (W-CDMA), Code Division Access (CDMA), Time Division Multiple Access (TDMA), Bluetooth, Wireless-Fidelity (WiFi) (for example, IEEE 802.11a, IEEE 802.11b, IEEE 802.11g and/or IEEE 802.11n), Voice over Internet Protocol (VoIP), Worldwide Interoperability for Microwave Access (Wi-Max), other protocols applicable to emails, instant messaging and short messages, and any other appropriate communication protocols.

The key module 106 provides an interface for a user to input to the mobile terminal; a user can enable the mobile terminal 10 to execute different functions by pressing different keys.

The audio module 107 provides an audio interface for a user and may include one or more microphones, one or more loudspeakers and an audio circuit. The audio circuit receives audio data from the peripheral interface 104, converts the audio data into electrical information and transmits the electrical information to the loudspeaker, which then converts the electrical information into a sonic wave that human ears can hear. The audio circuit also receive electrical information from the microphone, converts the electrical information into audio data and transmits the audio data to the peripheral interface 104 for further processing. The audio data may be acquired from the memory 101 or the radio frequency module 105. Besides, the audio data also may be stored to the memory 101 or transmitted out through the radio frequency module 105. In some examples, the audio module 107 may further include a headset jack, which is configured to provide an audio interface for a headset or other devices.

The touch control screen 108 provides an output-input interface between the mobile terminal and a user. In particular, the touch control screen 108 displays to a user a video output, the content of which may include text, graph, video and any combination thereof. Some output results correspond to some user interface objects. The touch control screen 108 further receives an input from a user, for example, gesture operations of the user such as clicking and sliding, so that the user interface object makes a response to the input from the user. The technology to detect the input from a user may be based on resistive, capacitive or any other possible touch control detection technologies. The specific example of the display unit of the touch control screen 108 includes but not limited to liquid crystal display or light-emitting polymer display.

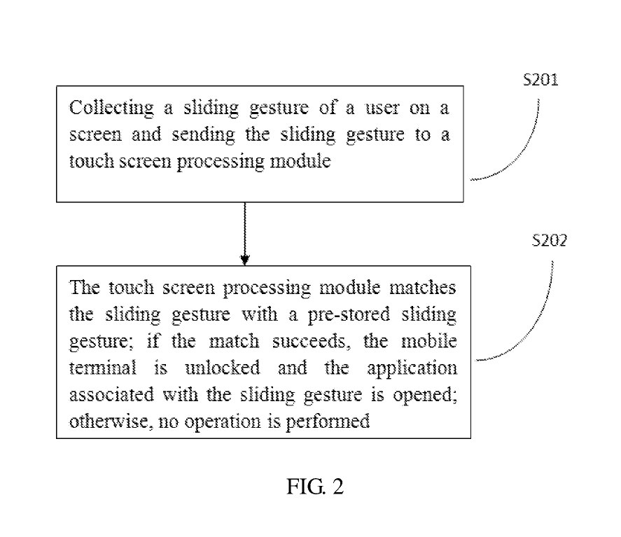

Please refer to FIG. 2, which is a flowchart illustrating a method for awakening a mobile terminal and an application provided by the first embodiment of the disclosure, the method mainly including:

S201: collecting a sliding gesture of a user on a screen and sending the sliding gesture to a touch screen processing module.

In particular, a capacitive touch sensor is used to collect the sliding gesture data of the user on the screen and the sliding gesture data is sent to the touch screen processing module.

S202: the touch screen processing module searches and matches the sliding gesture with a pre-stored sliding gesture; if the match succeeds, the mobile terminal is unlocked and the application associated with the sliding gesture is opened; otherwise, no operation is performed.

For the sliding gesture matched unsuccessfully, it might be caused by random sliding or other touch; however, actually, it might be an error sliding gesture input by a user due to carelessness; therefore, several sliding opportunities are set generally; if the match succeeds once within the several sliding opportunities, the mobile terminal is unlocked and the application associated with the sliding gesture is opened; if none of the match succeeds within the several sliding opportunities, it is impossible to awaken the mobile terminal or the mobile terminal cannot be unlocked and the application associated with the sliding gesture cannot be opened within a period of time. The period of time may be set as 5 minutes or 10 minutes and the like.

In particular, during the process of matching the sliding gesture with a pre-stored sliding gesture, a touch screen gesture recognition technology is employed, which realizes gesture recognition by processing the multipoint graph input by a user with operations such as rotating, translating, scaling, sampling and template-comparison through a touch screen gesture recognition algorithm.

The method for awakening a mobile terminal and an application provided by this embodiment, by binding a sliding gesture to an application, allows a user to open the application while awakening the mobile terminal through the sliding gesture, bringing a great convenience for a user to quickly open a corresponding application and omitting the process of finding application after awakening a mobile phone.

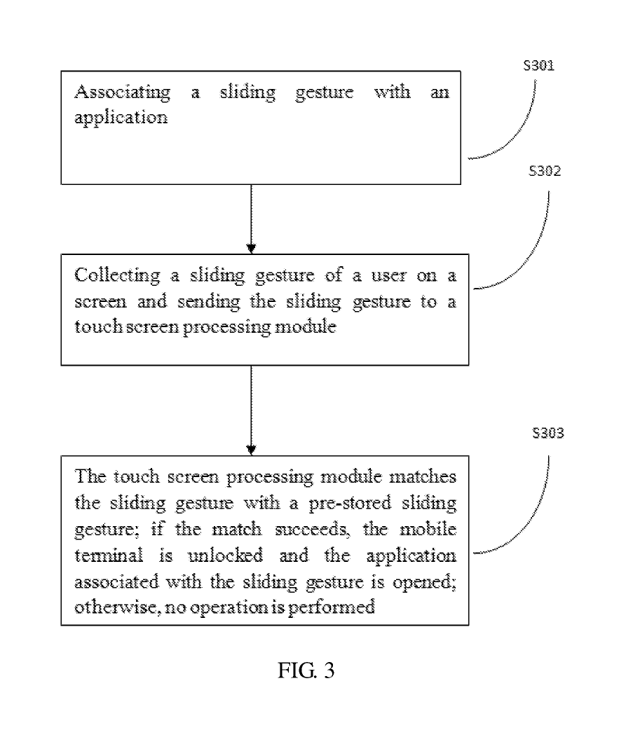

Please refer to FIG. 3, which is a flowchart illustrating a method for awakening a mobile terminal and an application provided by the second embodiment of the disclosure, the method mainly including:

S301: associating a sliding gesture with an application.

In particular, first a sliding gesture is recorded and is associated with a corresponding application, and then is saved in a corresponding table entry of user configurations.

Further, a user can define the association relationship between a sliding gesture and an application, for example, define a sliding gesture “W” to associate with WeChat, define a sliding gesture “E” to open e-mail, or define some sliding gestures to associate respectively with camera, short message, phonebook and so on; generally, the user-defined sliding gesture at least needs to avoid being unlocked by unintentional touch.

S302: collecting a sliding gesture of a user on a screen and sending the sliding gesture to a touch screen processing module.

In particular, a capacitive touch sensor is used to collect the sliding gesture data of the user on the screen and the sliding gesture data is sent to the touch screen processing module.

S303: the touch screen processing module matches the sliding gesture with a pre-stored sliding gesture; if the match succeeds, the mobile terminal is unlocked and the application associated with the sliding gesture is opened; otherwise, no operation is performed.

In particular, the touch screen processing module searches and matches the sliding gesture with a sliding gesture pre-stored in the corresponding table entry of user configurations; if the match succeeds, the mobile terminal is unlocked and the application associated with the sliding gesture is opened; otherwise, no operation is performed, at this time, the sliding gesture might be caused by random sliding or other touch; however, actually, it might be an error sliding gesture input by a user due to carelessness; therefore, several sliding opportunities are set generally; if the match succeeds once within the several sliding opportunities, the mobile terminal is unlocked and the application associated with the sliding gesture is opened; if none of the match succeeds within the several sliding opportunities, it is impossible to awaken the mobile terminal or the mobile terminal cannot be unlocked and the application associated with the sliding gesture cannot be opened within a period of time. The period of time may be set as 5 minutes or 10 minutes and the like.

The method for awakening a mobile terminal and an application provided by this embodiment, by means of binding a sliding gesture to an application, allows a user to open the application while awakening the mobile terminal through the sliding gesture, bringing a great convenience for a user to quickly open a corresponding application and omitting the process of finding application after awakening a mobile phone, and a user can set a gesture corresponding to each application according to his/her preference and habit by this method, with good experience.

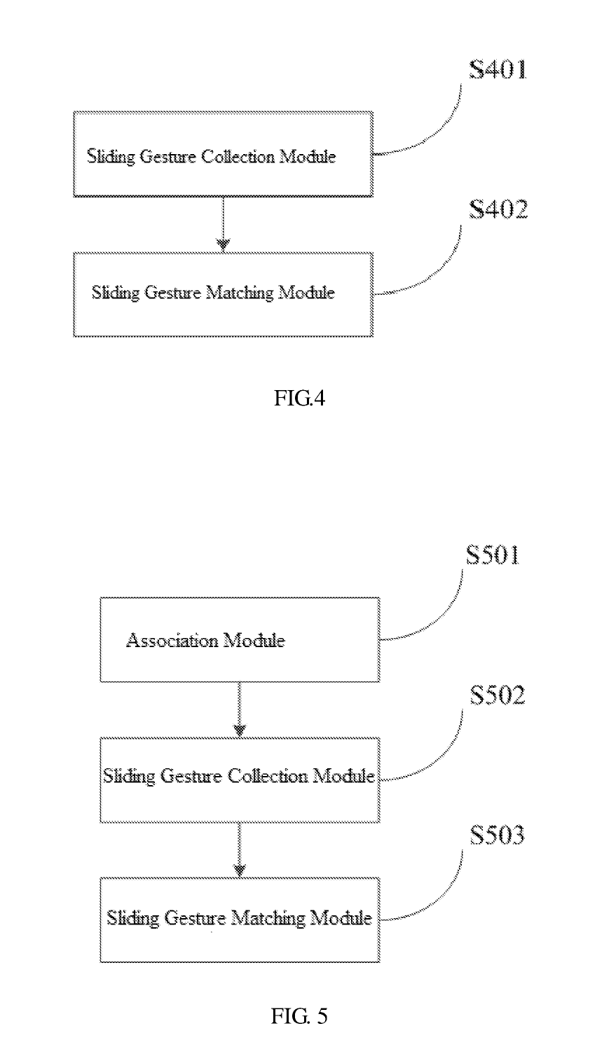

Please refer to FIG. 4, which is a structure diagram of a system for awakening a mobile terminal and an application provided by the third embodiment of the disclosure, the system mainly including: a sliding gesture collection module 401 and a sliding gesture matching module 402, each of which is described below in detail.

The sliding gesture collection module 401 is configured to collect a sliding gesture of a user on a screen and send the sliding gesture to a touch screen processing module.

In particular, the sliding gesture collection module 401 is configured to collect the sliding gesture data of the user on the screen using a capacitive touch sensor and send the sliding gesture data to the touch screen processing module.

The sliding gesture matching module 402 is configured to: search and match the sliding gesture with a pre-stored sliding gesture; if the match succeeds, unlock the mobile terminal and open the application associated with the sliding gesture; otherwise, perform no operation.

For the sliding gesture matched unsuccessfully, it might be caused by random sliding or other touch; however, actually, it might be an error sliding gesture input by a user due to carelessness; therefore, several sliding opportunities are set generally; if the match succeeds once within the several sliding opportunities, the mobile terminal is unlocked and the application associated with the sliding gesture is opened; if none of the match succeeds within the several sliding opportunities, it is impossible to awaken the mobile terminal or the mobile terminal cannot be unlocked and the application associated with the sliding gesture cannot be opened within a period of time. The period of time may be set as 5 minutes or 10 minutes and the like.

In particular, during the process of matching the sliding gesture with a pre-stored sliding gesture, a touch screen gesture recognition technology is employed, which realizes gesture recognition by processing the multipoint graph input by a user with operations such as rotating, translating, scaling, sampling and template-comparison through a touch screen gesture recognition algorithm.

The system for awakening a mobile terminal and an application provided by this embodiment, by binding a sliding gesture to an application, allows a user to open the application while awakening the mobile terminal through the sliding gesture, bringing a great convenience for a user to quickly open a corresponding application and omitting the process of finding application after awakening a mobile phone.

Please refer to FIG. 5, which is a structure diagram of a system for awakening a mobile terminal and an application provided by the fourth embodiment of the disclosure, the system mainly including: an association module 501, a sliding gesture collection module 502 and a sliding gesture matching module 503, each of which is described below in detail.

The association module 501 is configured to associate a sliding gesture with an application.

In particular, the association module 501 is configured to record a sliding gesture, associate the sliding gesture with a corresponding application, and save the sliding gesture in a corresponding table entry of user configurations.

Further, a user can define the association relationship between a sliding gesture and an application, for example, define a sliding gesture “W” to associate with WeChat, define a sliding gesture “E” to open e-mail, or define some sliding gestures to associate respectively with camera, short message, phonebook and so on; a user can set a sliding gesture according to his/her preference and habit; however, the user-defined sliding gesture generally at least needs to avoid being unlocked by unintentional touch.

The sliding gesture collection module 502 is configured to collect a sliding gesture of a user on a screen and send the sliding gesture to a touch screen processing module.

In particular, the sliding gesture collection module 502 is configured to collect the sliding gesture data of the user on the screen using a capacitive touch sensor and send the sliding gesture data to the touch screen processing module.

The sliding gesture matching module 503 is configured to: search and match the sliding gesture with a pre-stored sliding gesture; if the match succeeds, unlock the mobile terminal and open the application associated with the sliding gesture; otherwise, perform no operation.

In particular, the sliding gesture matching module 503 is configured to: search and match the sliding gesture with a sliding gesture pre-stored in the corresponding table entry of user configurations; if the match succeeds, unlock the mobile terminal and open the application associated with the sliding gesture; otherwise, perform no operation; at this time, the sliding gesture might be caused by random sliding or other touch; however, actually, it might be an error sliding gesture input by a user due to carelessness; therefore, several sliding opportunities are set generally; if the match succeeds once within the several sliding opportunities, the mobile terminal is unlocked and the application associated with the sliding gesture is opened; if none of the match succeeds within the several sliding opportunities, it is impossible to awaken the mobile terminal or the mobile terminal cannot be unlocked and the application associated with the sliding gesture cannot be opened within a period of time. The period of time may be set as 5 minutes or 10 minutes and the like.

The system for awakening a mobile terminal and an application provided by this embodiment, by binding a sliding gesture to an application, allows a user to open the application while awakening the mobile terminal through the sliding gesture, bringing a great convenience for a user to quickly open a corresponding application and omitting the process of finding application after awakening a mobile phone, and a user can set a gesture corresponding to each application according to his/her preference and habit by this system, with good experience.

The embodiment of the disclosure provides a terminal for awakening a mobile terminal and an application, including: one or more processors;

a memory;

one or more programs stored in the memory, which, when executed by the one or more processors, are configured to:

collect a sliding gesture of a user on a screen; search and match the sliding gesture with a pre-stored sliding gesture; and, if the match succeeds, unlock the mobile terminal and open the application associated with the sliding gesture.

In the embodiments provided in this application, it should be understood that the disclosed device and method may be realized through other ways. For example, the device embodiments described above are exemplary simply; for example, the division of module is a division of logical functions simply, which can select other division methods during actual implementation.

The module described as a separate component may be or may not be physically separated; the component, displayed as a module, may be or may not be a physical module, that is, it may be located at one place, or may be distributed on multiple network modules. Part or all modules can be selected to realize the purpose of the embodiment scheme according to actual needs.

In addition, each function module in each embodiment of the disclosure may be integrated in a processing module, or exist as a physical module separately, or two or more modules are integrated in a module. The above integrated modules may be realized in the form of hardware, or in the form of software function module.

When the integrated modules are realized in the form of software function modules and are sold or used as an independent product, they can be stored in a computer readable storage medium. Based on this understanding, the technical scheme of the disclosure or the part making a contribution to the existing technology or part or all of the entire technical scheme on essence may be embodied in the form of software product. This computer software product is stored in a storage medium, including a number of instructions that enable a computer device (which may be a computer, a server or a network device, etc.) to execute all or part of the methods described in each embodiment of the disclosure. The aforementioned storage medium includes: USB flash disk, mobile hard disk, Read-Only Memory (ROM), Random Access Memory (RAM), diskette or compact disc and various mediums that can store program codes.

It should be noted that, for ease of description, the method embodiments described above are expressed as a combination of a series of actions. However, those skilled in the art should understand that the disclosure is not limited by the execution order of the described actions, because some steps can be executed in a different order or simultaneously according to the disclosure. Next, those skilled in the art should also understand that all embodiments described in the specification are preferred embodiments and not all actions and modules involved in the embodiments are necessary to the disclosure.

Each of the above embodiments has a different focus in description; for the part not detailed in one embodiment, please refer to relevant description in other embodiments.

The above are the description of a method and a system for awakening a mobile terminal and an application provided by the disclosure; for those skilled in the art, although according to the idea of the embodiment of the disclosure, changes will happen to both the specific embodiments and application scope. Thus, the content of the specification should not be understood as a limit to the disclosure.

An embodiment of the present application provides a nonvolatile computer storage media having computer executable instructions stored thereon, wherein the computer executable instructions can perform any one of the methods for alleviating light leakage of a monitor in the foregoing embodiments of methods.

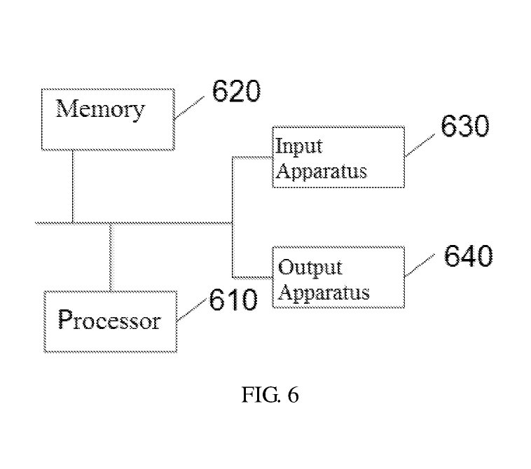

FIG. 6 shows the hardware configuration of an terminal for the method for awakening a mobile terminal and an application provided in the embodiments of the present application, as shown in FIG. 6, this terminal includes:

one or more processors 610 and a memory 620, in FIG. 6, one memory 610 is employed as an example.

The terminal for executing the method for awakening a mobile terminal and an application may further comprise: an input apparatus 630 and an output apparatus 640.

The processor 610, the memory 620, the input apparatus 630 and the output apparatus 640 may be connected via a bus or other means, in FIG. 6, a connection via a bus is taken as an example.

As a nonvolatile computer readable storage media, the memory 620 can be used to store nonvolatile software program, nonvolatile computer executable program and module, such as the program instructions/modules corresponding to the method for awakening a mobile terminal and an application in the embodiments of the present application (e.g., the sliding gesture collection module 401 and the sliding gesture matching module 402 as shown in FIG. 4). The processor 610 executes various functions and applications of a server and data processing by running a nonvolatile software program, instructions and a module stored in the memory 620, so as to carry out the method for awakening a mobile terminal and an application in the embodiments of method.

The memory 620 may include a program storage area and a data storage area, wherein the program storage area can store an operating system, an application program required for at least one function; the data storage area can store the data created based on the use of the apparatus for alleviating light leakage of a monitor, or the like. Further, the memory 620 may include high-speed random access memory, and may further include nonvolatile memory, such as at least one disk storage device, flash memory device, or other nonvolatile solid-state memory devices. In some embodiments, the memory 620 optionally includes a memory remotely located with respect to the processor 610, which may be connected to an apparatus for alleviating light leakage of a monitor via a network. Examples of such network include, but not limited to, Internet, Intranet, local area network (LAN), mobile communication network, and combinations thereof.

The input apparatus 630 may receive the input numbers or characters information, as well as key signal input associated with user settings of the apparatus for awakening a mobile terminal and an application and function control. The output apparatus 640 may include a display screen or other display device.

The one or more modules are stored in the memory 620, and when being executed by the one or more processors 610, execute the method for awakening a mobile terminal and an application according to the above embodiments of method.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The terminal according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones, multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players, video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for awakening a mobile terminal and an application, comprising:
collecting a sliding gesture of a user on a screen;
searching and matching the sliding gesture with a pre-stored sliding gesture; and
if the matching is succeeded, unlocking the mobile terminal and opening the application associated with the sliding gesture.

2. The method for awakening a mobile terminal and an application according to claim 1, wherein: before the collecting a sliding gesture of a user on a screen, the method further comprises:
associating a sliding gesture with an application.

3. The method for awakening a mobile terminal and an application according to claim 2, wherein the associating a sliding gesture with an application specifically comprises:
recording a sliding gesture, associating the sliding gesture with a corresponding application, and saving the sliding gesture in a corresponding table entry of user configurations.

4. The method for awakening a mobile terminal and an application according to claim 1, wherein the collecting a sliding gesture of a user on a screen specifically comprises:
collecting the sliding gesture data of a user on a screen using a capacitive touch sensor.

5. The method for awakening a mobile terminal and an application according to claim 4, wherein: the matching the sliding gesture with a pre-stored sliding gesture specifically comprises:
searching and matching the sliding gesture with a sliding gesture pre-stored in the corresponding table entry of user configurations.

6. A terminal for awakening a mobile terminal and an application, comprising:
one or more processors;
a memory;
one or more programs stored in the memory, which, when executed by the one or more processors, are configured to:
collect a sliding gesture of a user on a screen;
match the sliding gesture with a pre-stored sliding gesture; and
if the match succeeds, unlock the mobile terminal and open the application associated with the sliding gesture.

7. The terminal according to claim 6, wherein the one or more programs are configured to:
before collect a sliding gesture of a user on a screen, associate a sliding gesture with an application.

8. The terminal according to claim 7, wherein the associate a sliding gesture with an application comprises:
record a sliding gesture, associate the sliding gesture with a corresponding application, and save the sliding gesture in a corresponding table entry of user configurations.

9. The terminal according to claim 6, wherein the collect a sliding gesture of a user on a screen comprises:
collect the sliding gesture data of a user on a screen using a capacitive touch sensor.

10. The terminal according to claim 6, wherein: the match the sliding gesture with a pre-stored sliding gesture comprises:
search and match the sliding gesture with a sliding gesture pre-stored in the corresponding table entry of user configurations.

11. A nonvolatile computer storage media, which has computer executable instructions stored thereon, wherein the computer executable instructions are configured to:
collect a sliding gesture of a user on a screen;
search and match the sliding gesture with a pre-stored sliding gesture; and
if the match is succeeded, unlock the mobile terminal and opening the application associated with the sliding gesture.

12. The nonvolatile computer storage media according to claim 11, wherein the computer executable instructions are configured to: before collect a sliding gesture of a user on a screen, associate a sliding gesture with an application.

13. The nonvolatile computer storage media according to claim 12, wherein the associate a sliding gesture with an application comprises:
record a sliding gesture, associate the sliding gesture with a corresponding application, and save the sliding gesture in a corresponding table entry of user configurations.

14. The nonvolatile computer storage media according to claim 11, wherein the collect a sliding gesture of a user on a screen comprises:
collect the sliding gesture data of a user on a screen using a capacitive touch sensor.

15. The nonvolatile computer storage media according to claim 11, wherein: the match the sliding gesture with a pre-stored sliding gesture comprises:
search and match the sliding gesture with a sliding gesture pre-stored in the corresponding table entry of user configurations.
